(19) United States
(12) Patent Application Publication
(10) Pub. No.: US 2017/0304843 A1
(43) Pub. Date: Oct. 26, 2017

(54) GRINDING SYSTEM FOR GRINDING A MATERIAL TO BE GROUND, AND METHOD FOR GRINDING A MATERIAL TO BE GROUND

(71) Applicants: ThyssenKrupp Industrial Solutions AG, Essen (DE); ThyssenKrupp AG, Essen (DE)

(72) Inventors: Olaf Hagemeier, Beckum (DE); Michael Wilczek, Warendorf (DE)

(73) Assignees: ThyssenKrupp Industrial Solutions AG, Essen (DE); ThyssenKrupp AG, Essen (DE)

(21) Appl. No.: 15/521,356

(22) PCT Filed: Aug. 18, 2015
(86) PCT No.: PCT/EP2015/068886

§ 371 Date: Apr. 24, 2017

(30) Foreign Application Priority Data
Oct. 22, 2014 (DE) 10 2014 015 549.8

(51) Int. Cl. B02C 23/08; B02C 15/00; B02C 17/16; B02C 23/02

(52) U.S. Cl. CPC B02C 23/08; B02C 23/02; B02C 15/00; B02C 17/161

(57) ABSTRACT

A grinding installation for comminuting material may include a grinding apparatus and a classifying device that is connected to the grinding apparatus and classifies the material. The classifying device may include a static classifier and a dynamic classifier. The static classifier may be disposed so as to at least partially surround the dynamic classifier. The classifying device may comprise a coarse material outlet for discharging coarse material that comprises a coarse grain fraction, a grit outlet for discharging grit that comprises a medium grain fraction, and a finished material outlet for discharging finished material that comprises a fine grain fraction. The grinding installation may further include an open-loop/closed-loop control device for open-loop/closed-loop control of at least a part of a stream of material to the grinding apparatus. The present disclosure also concerns methods for comminuting material.

The invention relates to a grinding installation for comminuting material for grinding, and to a method for comminuting material for grinding.

### PRIOR ART

It is known for material for grinding, such as for example limestone, dolomite, ores, clinker, slag or fly ash to be comminuted in a grinding installation which comprises at least one grinding apparatus and one classifier.

DE 102011055762 A1 has disclosed a grinding installation for comminuting material for grinding, which grinding installation comprises a classifying device with a static classifier and a dynamic classifier and with at least one grinding apparatus.

The material for grinding is normally fed into the classifier or the grinding apparatus. In the classifier, the material for grinding is classified into a fine grain fraction and a coarse grain fraction, wherein the coarse grain fraction is fed to the grinding device for comminution. Following the comminution, the material for grinding is classified in the classifier again, wherein the coarse material for grinding is supplied to the grinding device again. During the operation of the grinding installation, it is often the case that irregular process fluctuations occur, which involve for example natural fluctuations in the condition of the material for grinding, such as for example grain size or density. Such process fluctuations lead to overloading of the grinding apparatus, wherein adequate comminution of the material for grinding is no longer achieved in the grinding apparatus. This leads firstly to increased wear of the grinding apparatus and secondly to a situation in which the material for grinding that has not been adequately comminuted is supplied to the grinding apparatus again, and the grinding process is lengthened considerably.

### DISCLOSURE OF THE INVENTION

Taking this as a starting point, it is an object of the present invention to provide a grinding installation which overcomes the disadvantages described above and which prevents overloading of the grinding apparatus and permits efficient comminution of the material for grinding.

Said object is achieved according to the invention by means of a grinding installation comprising the features of independent device claim 1 and by way of a method comprising the features of independent method claim 9. Advantageous refinements emerge from the dependent claims.

A grinding installation for comminuting material for grinding comprises, according to a first aspect, at least one grinding apparatus and a classifying device which is connected to the at least one grinding apparatus and which serves for classifying the material for grinding and which comprises a static classifier and a dynamic classifier, wherein the static classifier is arranged so as to at least partially surround the dynamic classifier. The classifying device comprises at least one coarse material outlet for the discharge of coarse material which comprises a coarse grain fraction, at least one grit outlet for the discharge of grit which comprises a medium grain fraction, and at least one finished material outlet for the discharge of finished material which comprises a fine grain fraction. Coarse material is preferably to be understood to mean a material for grinding with a grain size of approximately 10-100 mm, grit is to be understood to mean a material for grinding with a grain size of approximately 1-10 mm and finished material is to be understood to mean a material for grinding with a grain size of approximately 30-300 μm. Furthermore, the grinding installation comprises an open-loop/closed-loop control device for open-loop/closed-loop control of at least a part of the stream of material for grinding to the at least one grinding apparatus.

With the open-loop/closed-loop control device for open-loop/closed-loop control of at least a part of the stream of material for grinding, overloading of the at least one grinding apparatus is reliably avoided. Overloading of the grinding apparatus occurs if the stream of material for grinding into the grinding apparatus exceeds the optimum operating point of the grinding apparatus of for example 250-350 t/h, in particular approximately 300 t/h.

Closed-loop control of the stream of material for grinding is to be understood to mean that a maximum value of the stream of material for grinding, such as for example 300 t/h, is defined and, in the event of the actual value of the stream of material for grinding being exceeded, said value is changed so as to reach or fall below the maximum value of the stream of material for grinding. Open-loop control of the stream of material for grinding is to be understood to mean the targeted influencing of the stream of material for grinding to the at least one grinding device without feedback.

The material for grinding preferably involves brittle materials such as limestone, dolomite or ore material. In particular, in the case of cement production, the material for grinding comprises clinker, slag, cement, cement raw material, cement-containing substances and/or fly ash.

The grinding apparatus comprises for example a roller press or a ball mill in which the material for grinding is comminuted.

The classifying device comprises a static classifier and a dynamic classifier. The classifying device preferably comprises a first inlet for the admission of a first material stream, for example from a roller mill and/or a fresh material feed, into the classifying device and at least one second inlet for the admission of a second material stream, for example from a ball mill, into the classifying device. The classifying device furthermore comprises, for example, a distributor device which is designed so as to supply the material stream from the first inlet to the static classifier and to supply the material stream from the second inlet to the dynamic classifier, wherein the static classifier and the dynamic classifier are connected such that a stream of material for grinding from the static classifier into the dynamic classifier is made possible.

The stream of material for grinding enters the first inlet of the classifying device via a fresh material feed and is supplied via a distributor device to the static classifier. A static classifier comprises a multiplicity of flow devices, for example guide vanes, which serve for the deagglomeration of the material stream flowing through the static classifier. The static classifier is in particular designed so as to form a cylindrical classifying zone between the flow devices, and the dynamic classifier is arranged within the static classifier. Classifying air is supplied to the static classifier via a classifying air duct, for example by way of a blower, which classifying air is conducted by means of the multiplicity of guide vanes of the flow device, against the material stream flowing through the static classifier.

The relatively coarse grain fraction, the coarse material, of the material stream flowing into the classifying device through the first inlet exits the static classifier through the coarse material outlet, wherein the relatively fine grain fraction of the material for grinding is conducted pneumatically to the dynamic classifier by the classifying air.

A dynamic classifier comprises a moving classifying zone, for example a rotating rod cage, which is entered by a material stream with small grain size, in particular up to approximately 10 mm. The dynamic classifier is for example arranged coaxially with respect to the static classifier and rotationally symmetrically with respect to the drive axle of the moving classifying zone. The material stream of medium grain size, the grit, is deflected by the dynamic classifier and emerges from the classifying device through the grit outlet. The stream of material for grinding passing through the dynamic classifier comprises a grain size of up to approximately 300 μm and exits the classifying device through the finished material outlet.

The material for grinding emerging from the coarse material outlet and that emerging from the grit outlet is, for comminution, conducted to at least one grinding apparatus. For example, the coarse material is conducted to a roller mill and the grit is conducted to a ball mill, or the coarse material and the grit are merged and supplied to a single grinding apparatus, for example a roller mill or a ball mill.

Following the comminution, the material for grinding is supplied to the classifying device and enters the latter through the second inlet of the classifying device. The material stream entering the classifying device through the second inlet is supplied to the dynamic classifier via a distributor device, wherein the material deflected by the dynamic classifier exits the classifying device through the coarse material outlet, and the material that has passed into the moving classifying zone of the dynamic classifier exits the classifying device through the finished material outlet.

The open-loop/closed-loop control device controls the stream of material for grinding to the at least one grinding apparatus in closed-loop/open-loop fashion, wherein said stream of material for grinding comprises for example the stream of material for grinding between the grit outlet of the classifying device and the inlet of the grinding apparatus, the stream of material for grinding between the coarse material outlet and the inlet of the grinding apparatus, or the stream of material for grinding between the coarse material outlet, the grit outlet and the inlet of the grinding apparatus.

In a first embodiment, the open-loop/closed-loop control device comprises a dosing device which is arranged between the grit outlet and the at least one grinding apparatus and which is designed so as to limit at least a part of the stream of material for grinding to the at least one grinding apparatus. A dosing device is to be understood to mean a device which continuously conveys a certain settable flow rate of material for grinding. A dosing device of said type involves for example a conveyor belt which draws material out of a bunker and which comprises a height limit or involves a cellular wheel sluice or conveying screw which is designed so as to be operable at a constant rotational speed and so as to convey a maximum stream of material for grinding of approximately 300-400 t/h, in particular approximately 300 t/h. A dosing device which limits the stream of material for grinding reliably prevents a very large stream of material for grinding, such as arises in the event of suddenly occurring process fluctuations, from flowing into the grinding apparatus and exceeding the maximum capacity thereof. The dosing device thus permits optimum operation of the grinding apparatus. The arrangement of the dosing device between the grit outlet and the inlet of the at least one grinding apparatus offers the advantage that the supply of the grit of medium grain size to the at least one grinding apparatus is dosed and for example does not exceed a certain maximum value. In this way, an excessively high flow rate of grit in the grinding apparatus is avoided. In particular, the grit which comprises a smaller grain size than the coarse material results in rough running of the grinding apparatus. A lower flow rate of grit makes it possible for the grinding apparatus to be operated more efficiently with a larger amount of material for grinding, because a large fraction of grit in the material for grinding for example has the effect that the material for grinding floats upward in the grinding apparatus during the grinding process, thus resulting in inefficient grinding.

In a further embodiment, the open-loop/closed-loop control device comprises at least one measurement device for determining a stream of material for grinding to the at least one grinding apparatus. A measurement device of said type involves for example an electromagnetic measurement sensor, an inductive throughflow meter or a mechanical throughflow meter such as a baffle plate or a belt weigher. The open-loop/closed-loop control device comprises for example two measurement devices, wherein one measurement device determines the stream of material for grinding from the coarse material outlet and a further measurement device determines the stream of material for grinding from the grit outlet.

A measurement device of said type for measuring the stream of material for grinding to the grinding apparatus permits closed-loop control of the stream of material for grinding in a manner dependent on the measured stream of material for grinding. If the stream of material for grinding exceeds a particular value, which corresponds for example to the maximum capacity of the grinding apparatus, it is for example the case that the fresh material stream fed into the grinding installation is reduced.

In a further embodiment, the measurement device is arranged between the dosing device and the at least one grinding apparatus. Said arrangement permits closed-loop control of the stream of material for grinding before the maximum conveying rate of the dosing device is reached. If the stream of material for grinding increases intensely for process reasons, this is registered by the measurement device and, for example proceeding from a particular value which lies below the maximum conveying rate of the dosing device, the feed rate of fresh material fed into the grinding installation is reduced.

In the event of a reduction of the fresh material flow rate, it is normally the case that, after a time delay, a reduction of the stream of material for grinding to the grinding apparatus occurs. However, the dosing device prevents an increase of the stream of material for grinding to values above the optimum operating point of the grinding apparatus.

In a further embodiment, the grinding installation comprises a fresh material feed for the admission of fresh material into the grinding installation, wherein the open-loop/closed-loop control device is connected to the fresh material feed, and designed, such that, when the stream of material for grinding, determined by means of the measurement device, from the grit outlet to the at least one grinding apparatus reaches a threshold value, said open-loop/closed-loop control device reduces the fresh material stream entering the grinding installation via the fresh material feed.

In a further embodiment, a buffer store is arranged between the grit outlet and the at least one grinding apparatus. The buffer store is preferably arranged upstream of the dosing device, such that, in the presence of a stream of material for grinding which is greater than the maximum stream of material for grinding that can be conveyed by the dosing device, the material for grinding is stored in the buffer store. The buffer store preferably comprises an outlet cone of the classifying device, which adjoins the grit outlet of the material for grinding classified in the static classifier. The arrangement of the buffer store between the grit outlet and the at least one grinding apparatus permits buffering of the grit, which corresponds to only a partial stream of the overall stream of material for grinding. This permits targeted buffering of a partial stream, wherein the buffer store comprises for example a small structural height. The buffer store furthermore offers the possibility of temporary storage of the grit while the fresh material stream via the fresh material feed is reduced in reaction to the exceedance of the maximum stream of material for grinding.

In a further embodiment, the grinding installation comprises a first grinding apparatus, in particular a roller press, and a second grinding apparatus, in particular a ball mill, wherein the grit outlet is connected to an inlet of the second grinding apparatus, and wherein the buffer store comprises an overflow which is connected to the first grinding apparatus. An overflow of said type preferably comprises an overflow line which conveys grinding material out of the buffer store. By means of the overflow, a build-up of the material for grinding in the buffer store is limited. This permits the use of a small buffer store and prevents the material for grinding from building up for example as far as the dynamic classifier.

In a further embodiment, the overflow comprises a measurement device for measuring the mass stream flowing through the overflow. This permits monitoring of the stream of material for grinding flowing from the buffer store to the first grinding apparatus.

A method for comminuting material for grinding comprises, according to a first aspect, at least the steps:

comminuting the material for grinding in at least one grinding apparatus,
classifying the material for grinding in a classifying device into coarse material, grit and fine material, wherein the classifying device comprises a static classifier and a dynamic classifier, wherein the static classifier is arranged so as to at least partially surround the dynamic classifier, and wherein the stream of material for grinding to the at least one grinding apparatus is controlled in open-loop/closed-loop fashion by means of an open-loop/closed-loop control device.

The advantages described above with reference to the grinding installation apply, correspondingly in method terms, to the method for comminuting grinding material.

### PREFERRED EXEMPLARY EMBODIMENTS OF THE INVENTION

The invention will be discussed in more detail below on the basis of multiple exemplary embodiments with reference to the appended figures. Here, statements such as “above” and “below” or “left” and “right” serve for better explanation of the schematic illustration of the exemplary embodiments of the invention shown in the figures, without the invention being restricted to the exemplary embodiments shown or to a particular installation position.

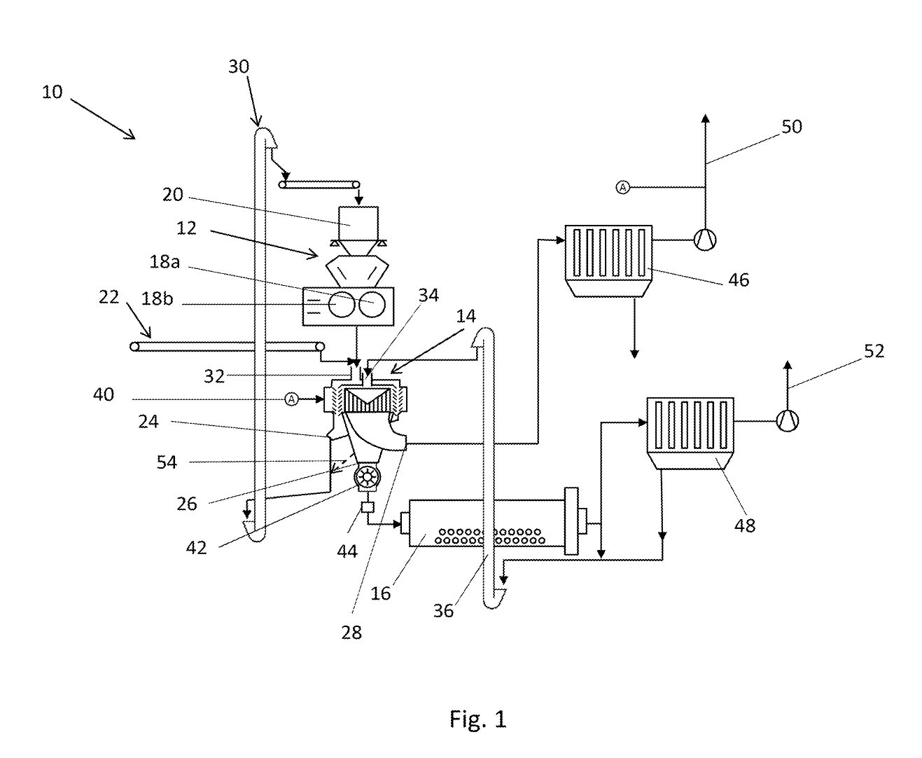

FIG. 1 shows a schematic illustration of a grinding installation comprising a classifying device and comprising two grinding apparatuses according to an exemplary embodiment.

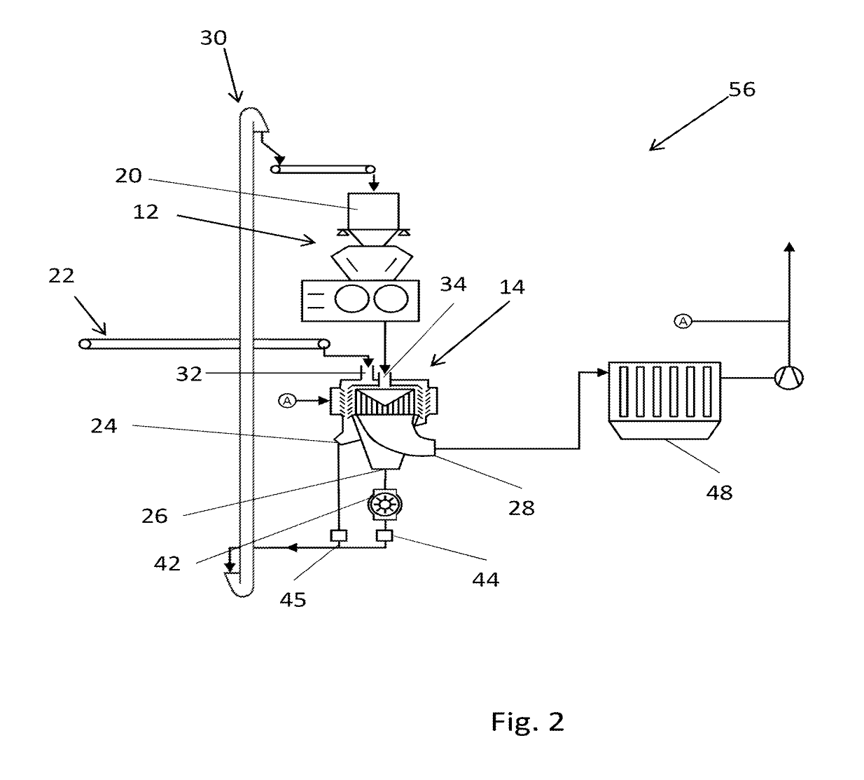

FIG. 2 shows a schematic illustration of a grinding installation comprising a classifying device and comprising a roller press according to a further exemplary embodiment.

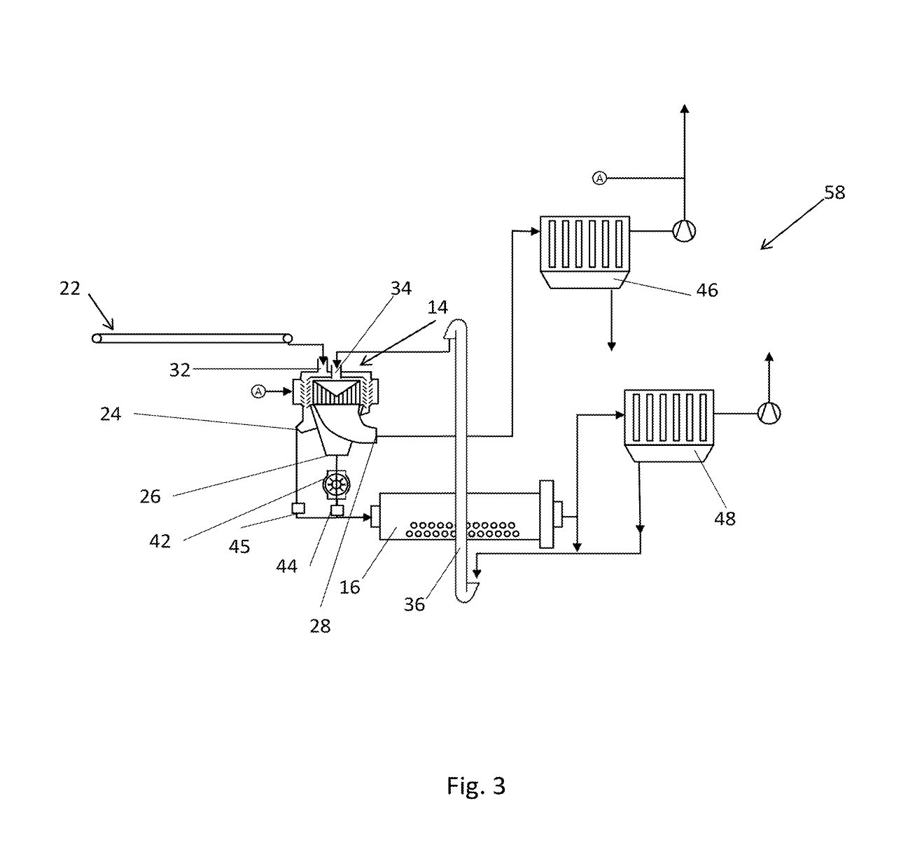

FIG. 3 shows a schematic illustration of a grinding installation comprising a classifying device and comprising a ball mill according to an exemplary embodiment.

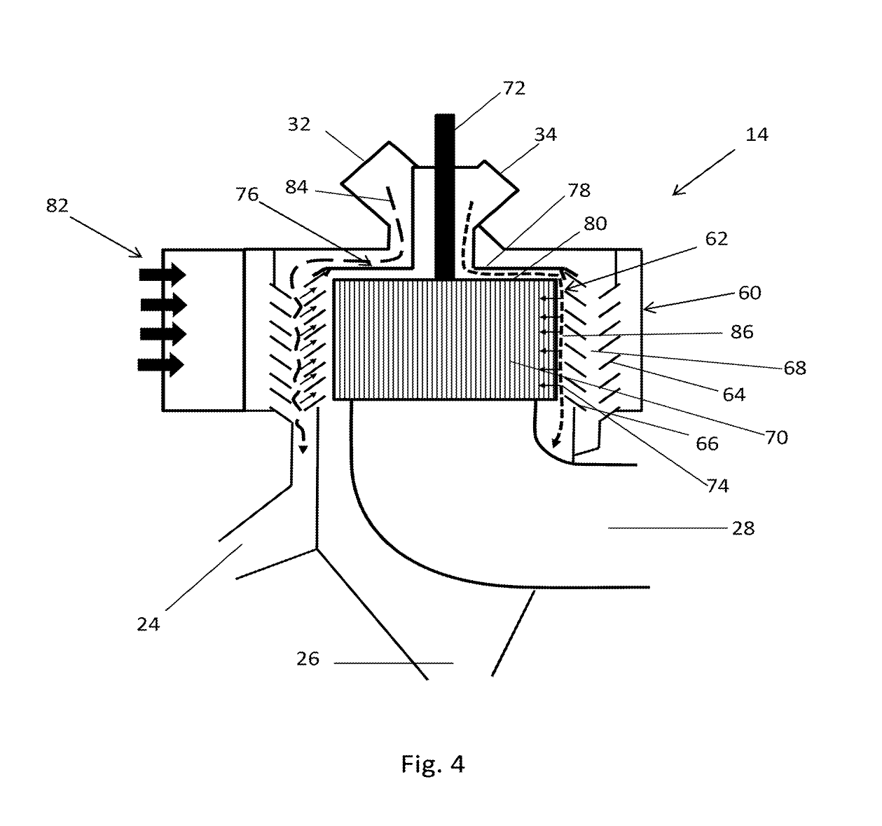

FIG. 4 shows a schematic illustration of a classifying device according to FIGS. 1 to 3.

FIG. 1 shows a grinding installation 10 for comminuting brittle material for grinding, such as for example limestone, clinker, dolomite or ore material. The grinding installation 10 comprises a first grinding apparatus 12, a classifying device 14 and a second grinding apparatus 16.

The first grinding apparatus 12 is, in the exemplary embodiment illustrated in FIG. 1, a roller press with two oppositely rotating grinding rollers 18a, 18b which, by means of a pressing device not illustrated in FIG. 1, are acted on with grinding pressures of up to 250 MPa, wherein a grinding gap is maintained between the grinding rollers 18a, 18b. The roller press furthermore comprises a feed shaft 20 which is arranged above the grinding rollers 18a and 18b. The feed shaft 20 comprises a tubular upper section and a funnel-shaped lower section for conducting material for grinding into the grinding gap between the grinding rollers 18a and 18b. Furthermore, the roller press 12 comprises an outlet opening 38 for the discharge of material for grinding that has been ground by the grinding rollers 18a, 18b.

The classifying device 14 comprises a static classifier and a dynamic classifier and is arranged below the first grinding apparatus 12. Furthermore, the classifying device 14 comprises a first inlet 32 and a second inlet 34 for the admission of a material stream, and three outlets, wherein a coarse material outlet 24, for discharging coarse material classified out by the static classifier, a grit outlet 26, for discharging grit classified out by the dynamic classifier, and a finished material outlet 28, for discharging finished material that has passed through at least the dynamic classifier, are provided. The coarse material normally comprises a grain size of 10-100 mm, the grit normally comprises a grain size of approximately 1-10 mm, and the fine material normally comprises a grain size of approximately 30-300 μm. The detailed construction of the classifying device 14 is discussed in more detail with reference to FIG. 4.

The first inlet 32 of the classifying device 14 is connected to the outlet 38 of the first grinding apparatus 12, such that material for grinding is conducted by way of gravitational force from the outlet 38 into the classifying device. The connection between the first inlet 32 of the classifying device and the outlet 38 of the first grinding apparatus 12 is realized for example by way of a chute.

The second inlet 34 of the classifying device is connected to the outlet of the second grinding apparatus 16 by means of a further conveying device 36, by means of which material for grinding that has been ground in the ball mill is conveyed to the second inlet 34 of the classifying device.

The classifying device 14 furthermore comprises a classifying air inlet 40 for the admission of a classifying airstream into the static classifier.

The coarse material outlet 24 of the classifying device 14 is adjoined by a conveying device 30 which is schematically illustrated as a pipeline. A conveying device 30 of said type comprises for example a conveyor belt or a bucket conveyor for conveying material for grinding from the coarse material outlet 24 of the conveying device 14 to the feed shaft 20.

The grit outlet 26 of the classifying device 14 is adjoined by a dosing device 42. A dosing device 42 of said type is for example a gravel or cellular wheel sluice, the rotational speed of which can be controlled in closed-loop fashion and which, by way of rotating vane cells, conducts a predetermined maximum flow rate of material for grinding from the grit outlet 26 of the classifying device 14 to the second grinding apparatus 16.

The grit outlet 26 of the classifying device 14 for discharging grit is connected to the inlet of the second grinding apparatus 16. The connection is for example a conveying device (not illustrated in FIG. 1) such as for example a conveyor belt or a chute.

Between the dosing device 42 and the inlet of the second grinding apparatus 16 there is arranged a measurement device for measuring a mass flow from the classifying device 14 to the second grinding apparatus 16.

The second grinding apparatus 16 is arranged below the classifying device 14 and, in the exemplary embodiment illustrated in FIG. 1, is a ball mill, which comprises a tubular main body within which a multiplicity of grinding bodies are arranged, which grinding bodies grind the material for grinding, which is situated within the ball mill, for example by way of a rotation of the main body about the longitudinal axis.

The grinding installation 10 furthermore comprises a fresh material feed 22 which is schematically illustrated between the classifying device 14 and the first grinding apparatus 12. The fresh material feed 22 comprises, for example, conveyor belts and is arranged such that fresh material is supplied to an inlet of the classifying device 14.

The grinding installation 10 furthermore comprises two separators 46, 48 for separating the airstream from the material for grinding. A first separator 46 adjoins the finished material outlet 28 of the classifying device. The fine material-air mixture emerging from the finished material outlet 28 is separated, at the separator 46, into fine material and an airstream 50. A second separator 48 adjoins the outlet of the ball mill 16 for the purposes of separating the material for grinding which emerges from the ball mill from the air stream 52.

During the operation of the grinding installation 10, fresh material is fed into the first inlet 32 of the classifying device 14 via the fresh material feed 22. The fresh material is for example coarse-grained material for grinding.

The material for grinding flows through the first inlet 32 into the static classifier, in which said material for grinding is classified into coarse material and grit. The coarse material exits the classifying device through the coarse material outlet 24 and flows via the conveying device 30 to the feed shaft 20 of the roller press 12 and subsequently into the grinding gap between the grinding rollers 18a and 18b, in which gap said coarse material is ground. The material for grinding that is ground in the roller press 12 enters the first inlet 32 of the classifying device 14 and subsequently the static classifier of the classifying device 14, where said material for grinding is classified into coarse material and grit.

The grit exits the classifying device through the grit outlet 26. The dosing device 42 which adjoins the grit outlet 26 conveys a certain maximum flow rate of material for grinding, for example via a gravel sluice, to the inlet of the ball mill 16. The maximum flow rate of material for grinding amounts to for example 300-400 t/h, in particular 350 t/h. Normally, the grinding installation is operated such that the flow rate of material for grinding amounts to approximately 250-350 t/h, in particular 300 t/h. The dosing device 42 reliably prevents the materials stream of material for grinding from the grit outlet 26 to the inlet of the ball mill 16 from exceeding a settable maximum value, whereby optimum grinding in the ball mill 16 is realized, and overloading of the ball mill 16 is prevented.

If the flow rate of material for grinding exceeds the maximum conveying rate of the dosing device 42, the material for grinding collects above the dosing device 42 in the grit outlet 26 of the conveying device. To prevent the material for grinding from backing up into the classifying device 14, in particular into the dynamic classifier, a recirculation line (illustrated by dashed lines in FIG. 1) is arranged between the grit outlet 26 and the coarse material outlet 24. The recirculation of material for grinding that collects in the grit outlet 26 is realized for example by way of an overflow (not illustrated) in the region of the grit outlet 26. Furthermore, above the grit outlet 26, there is arranged a grit cone, in particular a buffer store, in which grit collects. If the material in the region of the grit outlet 26, in particular in the buffer store, exceeds a certain height, it is conducted via the overflow into the recirculation line 54 to the conveying device 30.

Downstream of the dosing device 42, the mass flow of the material for grinding is measured in the measurement device 44. The grinding installation 10 furthermore comprises an open-loop/closed-loop control device (not illustrated) which comprises for example the dosing device 42 and/or the measurement device 44. The mass flow detected by means of the measurement device 44 is transmitted for example to the open-loop/closed-loop control device which, if the mass flow exceeds a predetermined value, reduces the flow rate of fresh material via the fresh material feed 22 and thus reduces the flow rate of grit emerging from the grit outlet 26.

A dosing device 42 of said type offers the advantage that process fluctuations of the grinding installation are compensated, and overloading, an excessively high quantity of material for grinding in the ball mill, is prevented. By way of the open-loop/closed-loop control device, the feed of fresh material can be controlled in open-loop/closed-loop fashion in a manner dependent on the flow rate of grit entering the ball mill. In an overload situation in which the grit fraction in the fresh material that is fed in is very high, it is possible, already before the maximum conveying rate of the dosing device 42 is reached, for the flow rate of fresh material by the fresh material feed 22 to be reduced, and thus for the operation of the dosing device 42 with the maximum conveying rate to be restricted to a short period of time, or for the attainment of the maximum conveying rate to be prevented.

The material for grinding that emerges from the grit outlet 26 of the classifying device 14 enters the ball mill 16 and is ground therein. Downstream of the ball mill 16, the material for grinding is supplied, either via the separator 48 or directly, to the conveying device 36, which conveys the material for grinding to the second inlet 34 of the classifying device 14.

Via the second inlet 34, the material for grinding passes into the dynamic classifier and is classified into grit and finished material. The grit exits the classifying device 14 through the grit outlet 26, and the finished material exits the classifying device through the finished material outlet 28. Downstream of the finished material outlet 28, the mixture of material for grinding and air is separated into finished material and an air stream 50 by means of the separator 46.

FIG. 2 shows a grinding installation 56 comprising a roller mill 12 and a classifying device 14, which are arranged substantially correspondingly to those in the grinding installation 10 of FIG. 1. By contrast to the grinding installation 10 of FIG. 1, the grinding installation 56 in FIG. 2 does not comprise a ball mill 16.

Fresh material is fed into the first inlet 32 of the classifying device 14 via the fresh material feed 22. The coarse material exiting the classifying device 14 through the coarse material outlet 24 and the grit exiting the classifying device 14 through the grit outlet 26 are merged and are subsequently supplied via the conveying device 30 to the feed slot 20 of the roller mill. Between the conveying device 30 and the grit outlet 26 of the classifying device 14, there is arranged a dosing device 42 and a measurement device 44 for measuring the mass stream of material for grinding exiting the grit outlet 26. The dosing device 42 limits the flow rate of grit that is conveyed via the conveyor device 30 to the roller mill 12 to a maximum value, and thereby prevents an overload situation in which an excessively high flow rate of material for grinding, in particular grit, is conveyed to the roller mill 12. A further measurement device 45 is arranged between the coarse material outlet 24 and the conveyor device 30 for the purposes of determining the coarse material mass stream to the roller mill 12. The measurement devices 44 and 45 determines the flow rate of grit and coarse material and transmits said value for example to an open-loop/closed-loop control device (not illustrated) which, above a certain maximum value, for example 250-350 t/h, in particular 300 t/h, reduces the flow rate of fresh material entering the grinding installation 56 via the fresh material feed 22.

FIG. 3 shows a grinding installation 58 comprising a ball mill 16 and a classifying device 14 which are arranged substantially correspondingly to those in the grinding installation 10 of FIG. 1. By contrast to the grinding installation 10 of FIG. 1, the grinding installation 58 of FIG. 3 does not comprise a roller mill 12.

The coarse material exiting the classifying device 14 through the coarse material outlet 24 and the grit exiting the classifying device 14 through the grit outlet 26 are merged and supplied to the ball mill 16. A dosing device 42 and a measurement device 44 for measuring the mass stream of material for grinding exiting the grit outlet 26 are arranged between the grit outlet 26 of the classifying device 14 and the inlet of the ball mill 16. The dosing device 42 limits the flow rate of grit that is conveyed to the ball mill 16 to a maximum value, and thereby prevents an overload situation. A further measurement device 45 is arranged between the coarse material outlet 24 and the inlet of the ball mill 16 for the purposes of determining the coarse material mass stream to the ball mill 16. The measurement devices 44 and 45 determines the flow rate of material for grinding to the ball mill 16 and transmit said value for example to an open-loop/closed-loop control device (not illustrated) which, above a certain maximum value, reduces the flow rate of fresh material entering the grinding installation 56 via the fresh material feed 22.

FIG. 4 shows a classifying device 14 according to FIGS. 1 to 3 comprising a static classifier 60 and a dynamic classifier 62. The static classifier 60 is arranged around the dynamic classifier 62 and comprises a cylindrical form. Furthermore, the static classifier comprises an outer cylindrical wall and, arranged radially to the inside thereof, a first, outer static flow device 64 and a second, inner static flow device 66. The first and the second flow device 64, 66 comprise in each case parallel guide vanes, wherein the guide vanes of the first flow device 64 are oriented so as to slope radially downward. The guide vanes of the second flow device 66 are oriented oppositely to the guide vanes of the first flow device 64. Between the first and the second flow device 64, 66 there is formed a cylindrical static classifying zone 68.

Within the static classifier 60, the dynamic classifier 62 is arranged radially to the inside of the second flow device 66. The dynamic classifier 62 comprises a rod cage 70 with rods running in an axial direction. The rod cage 70 is driven in rotation by means of a drive shaft 72 attached to the upper end of the rod cage. The dynamic classifier 62 is arranged coaxially with respect to the static classifier 60 and rotationally symmetrically with respect to the drive axle 72. The dynamic classifying zone 74 is formed between the rod cage and the second flow device 66. Furthermore, vertical, rod-like guide elements may be arranged in the dynamic classifying zone 74, which guide elements adjoin the flow device 64.

At the upper end of the rod cage 70 there is arranged a distributor device 76 which comprises a first disc 78 and a parallel second disc 80. The second disc 80 has the same diameter as the rod cage 70, is fixedly connected thereto, and forms a cover of the cylindrical rod cage 70. The first disc 78 is arranged parallel to and above the second disc 80 and is of ring-shaped form with a cutout in the center. Between the first disc 78 and the second disc 80 there is formed a passage. The first disc 78 and the second disc 80 are connected to one another, in a manner not illustrated, such that the rotation of the second disc 80, which is fixedly connected to the rod cage 70, effects a rotation of the first disc 78.

A first inlet 32 and a second inlet 34 for the admission of a material stream into the classifying device are arranged above the distributor device 76. The inlets 32, 34 comprise concentric openings arranged around the drive shaft 72, which comprises the inlets illustrated in tubular form, wherein the inlet opening of the first inlet 32 is arranged above the inlet opening of the second inlet 34. The drive shaft 72 of the dynamic classifier 62 extends centrally in an axial direction through the second inlet 32.

A classifying air duct 82 is arranged around the static classifier 60. The classifying air duct 82 is schematically illustrated laterally on the left-hand side of the static classifier 60. The classifying air duct 82 is fluidically connected to the static classifier, such that classifying air can flow from the outer wall of the static classifier 60 through the outer static flow device 64 into the classifying zone 68 of the static classifier 60. The flow direction of the classifying air is illustrated by the arrow direction in the classifying air duct 82.

FIG. 4 furthermore shows three outlets 24, 26, 28 for discharging the classified material stream from the classifying device 14. The coarse material outlet 24 comprises a duct which is arranged below the static classifying zone 68 such that the material that has been expelled in the static classifying zone falls into the duct and emerges from the classifying device 14 through the coarse material outlet 24. The grit outlet 26 comprises a duct which is arranged below the dynamic classifying zone 74 such that the material that has been expelled by the dynamic classifier falls into the duct and emerges from the classifying device 14 through the grit outlet 26. The finished material outlet 28 comprises a duct which is arranged below the rod cage 70 and through which the material that has passed through the static and the dynamic classifying stage 68, 74 emerges, together with the classifying air within the rod cage 70, from the classifying device 14.

During the operation of the classifying device 14, a coarse material stream flows in the arrow direction 84 through the first inlet 32 onto the first disc 78, which is driven in rotation by means of the drive axle 72. As a result of the rotation of the first disc 78, the material on the disc 78 is moved radially outward and passes, from above, into the static classifying zone 68 of the static classifier 60. The impingement of the material stream on the disc 78 and the rotation of the disc 78 additionally ensure a deagglomeration of the material.

From the outer wall of the static classifier 60, classifying air enters the static classifier 60 and flows through the outer flow device 64 against the material stream flowing through the static classifying zone 68. In the static classifying zone 68, the material stream is caused by the entering classifying air to be deflected radially inward toward the inner flow device 66. The coarse material flows through the static classifying stage following the action of gravitational force, and falls downward to the coarse material outlet 24. The relatively fine material is conveyed pneumatically by the classifying air through the inner flow device 66 into the dynamic classifying zone 74, in which it is again separated into a coarse material and a fine material. Here, the coarse material is expelled by the rods of the rod cage 70 and falls downward to the grit outlet 26. The fine material passes through the rods of the rod cage 70 into the interior of the rod cage and is discharged with the classifying air in the direction of the finished material outlet 28.

The classifying device 14 comprises three outlets 24, 26, 28 for three different grain fractions of the material stream. The material stream entering the classifying device 14 through the first inlet 32 is classified into three different grain fractions which exit the classifying device 14 through three different outlets 24, 26, 28.

The material stream entering the classifying device 14 through the second inlet 34 passes through the classifying device 14 in the arrow direction 86 and flows firstly onto the second disc 80, which is driven in rotation by the drive axle. The material is moved radially outward as a result of the rotation of the disc 80 and enters the dynamic classifying zone 74, which adjoins the second disc 80, in the dynamic classifier 62. As already described with reference to the material stream flowing into the classifying device 14 through the first inlet 32, the relatively coarse material falls downward through the dynamic classifying zone to the grit outlet 26.

The relatively fine material enters the rod cage 70 and is discharged downward in the direction of the finished material outlet 28 together with the classifying air.

The material entering the classifying device through the second inlet 34 is classified into two grain sizes, wherein the relatively fine material for grinding, in particular finished material, is discharged through the finished material outlet 28 and the relatively coarse material for grinding, in particular grit, is discharged from the classifying device 14 through the grit outlet 26.

The classifying device 14 makes it possible for two material streams of different grain size to be fed into the classifying device, wherein the first material stream is supplied both to the static classifier 60 and to the dynamic classifier 62, and the second material stream is supplied exclusively to the dynamic classifier 62. This makes it possible for a coarse material stream to be admitted through the first inlet 32, and for a relatively fine material stream to be admitted through the second inlet 34, into the classifying device 14.

The grinding apparatus which has been described with reference to FIGS. 1 to 3 and in which the classifying device 14 described with reference to FIG. 4 is arranged makes it possible to realize a considerable space-saving, because one classifying device is used for two material streams, and an additional classifier can be dispensed with. Furthermore, the described grinding installation makes it possible to dispense with additional guide elements between a static classifying device and a dynamic classifying device. With the grinding installation, it is furthermore the case that operation of the grinding apparatuses at their optimum operating point is ensured, thus permitting efficient comminution of the material for grinding.

### LIST OF REFERENCE DESIGNATIONS

10 Grinding installation
12 First grinding apparatus, roller press
14 Classifying device
16 Second grinding apparatus, ball mill
18a Grinding roller
18b Grinding roller
20 Feed shaft
22 Fresh material feed
24 Coarse fraction outlet
26 Grit outlet
28 Finished material outlet, fine material outlet
30 Conveyor device
32 First inlet of the classifying device
34 Second inlet of the classifying device
36 Conveyor device
38 Outlet opening of the first grinding apparatus
40 Classifying air inlet
42 Dosing device
44 Measurement device for measuring the mass stream
45 Measurement device for measuring the mass stream
46 Separator
48 Separator
50 Air stream
52 Air stream
54 Recirculation line
56 Grinding installation
58 Grinding installation
60 Static classifier
62 Dynamic classifier
64 Outer static flow device
66 Inner static flow device
68 Static classifying zone
70 Rod cage
72 Drive shaft
74 Dynamic classifying zone
76 Distributor device
78 First disc
80 Second disc
82 Classifying air duct

1.-13. (canceled)

14. A grinding installation for comminuting material, the grinding installation comprising:
a grinding apparatus;
a classifying device that is connected to the grinding apparatus and classifies the material, the classifying device comprising:
a static classifier,
a dynamic classifier, wherein the static classifier is disposed so as to at least partially surround the dynamic classifier,
a course material outlet for discharging course material that comprises a coarse grain fraction,
a grit outlet for discharging grit that comprises a medium grain fraction, and
a finished material outlet for discharging finished material that comprises a fine grain fraction; and
an open-loop/closed-loop control device for open-loop/closed-loop control of at least a part of a stream of the material to the grinding apparatus.

15. The grinding installation of claim 14 wherein the open-loop/closed-loop control device comprises a dosing device that is disposed between the grit outlet and the grinding apparatus and is configured to limit at least a part of the stream of the material to the grinding apparatus.

16. The grinding installation of claim 14 wherein the open-loop/closed-loop control device comprises a measurement device for determining at least a part of the stream of the material to the grinding apparatus.

17. The grinding installation of claim 16 wherein the open-loop/closed-loop control device comprises a dosing device that is disposed between the grit outlet and the grinding apparatus and is configured to limit at least a part of the stream of the material to the grinding apparatus, wherein the measurement device is disposed between the dosing device and the grinding apparatus.

18. The grinding installation of claim 16 further comprising a fresh material feed for admission of fresh material into the grinding installation, wherein the open-loop/closed-loop control device is connected to the fresh material feed and configured such that when the stream of the material from the grit outlet to the grinding apparatus reaches a threshold value as determined by the measurement device, the open-loop/closed-loop control device reduces a fresh material stream entering the grinding installation via the fresh material feed.

19. The grinding installation of claim 14 further comprising a buffer store disposed between the grit outlet and the grinding apparatus.

20. The grinding installation of claim 19 wherein the grinding apparatus is a first grinding apparatus, the grinding installation further comprising a second grinding apparatus, wherein the grit outlet is connected to an inlet of the second grinding apparatus, wherein the buffer store comprises an overflow that is connected to the first grinding apparatus.

21. The grinding installation of claim 20 wherein the first grinding apparatus is configured as a roller press.

22. The grinding installation of claim 20 wherein the second grinding apparatus is configured as a ball mill.

23. The grinding installation of claim 20 wherein the overflow comprises a measurement device for determining the stream of the material flowing through the overflow.

24. A method for comminuting material, the method comprising:
comminuting the material in a grinding apparatus;
classifying the material in a classifying device into coarse material, grit, and finished material, wherein the classifying device comprises a static classifier that is disposed so as to at least partially surround a dynamic classifier; and
controlling at least a part of a stream of the material to the grinding apparatus in open-loop/closed-loop fashion by an open-loop/closed-loop control device.

25. The method of claim 24 comprising limiting at least a part of the stream of the material to the grinding apparatus with a dosing device.

26. The method of claim 24 further comprising determining at least a part of the stream of the material to the grinding apparatus with a measurement device, wherein the controlling by the open-loop/closed-loop control device depends on the stream of the material determined by the measurement device.

27. The method of claim 26 further comprising:
admitting fresh material by way of a fresh material feed; and
controlling a flow rate of the fresh material in an open-loop/closed-loop fashion depending on the stream of the material determined by the measurement device.

28. The method of claim 24 wherein the grinding apparatus is a first grinding apparatus, the method further comprising:
comminuting the material in a second grinding apparatus;
conducting the coarse material to the first grinding apparatus;
conducting the grit to the second grinding apparatus; and
determining the stream of the material to the second grinding apparatus by way of a measurement device.

29. The method of claim 28 wherein the first grinding apparatus is configured as a roller mill.

30. The method of claim 28 wherein the second grinding apparatus is configured as a ball mill.
